(19) United States
(12) Patent Application Publication
(10) Pub. No.: US 2026/0145173 A1
(43) Pub. Date: May 28, 2026

(54) SAMPLE STORAGE CONTAINER

(71) Applicant: MAPLE LS CORPORATION, Gwangmyeong-si (KR)

(72) Inventor: YUN PARK, Seoul (KR)

(73) Assignee: MAPLE LS CORPORATION, Gwangmyeong-si (KR)

(21) Appl. No.: 19/348,264

(22) Filed: Oct. 2, 2025

(30) Foreign Application Priority Data
Oct. 31, 2024 (KR) 10-2024-0152419

(51) Int. Cl. B01L 3/00

(52) U.S. Cl. CPC B01L 3/50825; B01L 2200/12; B01L 2200/16; B01L 2300/042; B01L 2300/044; B01L 2300/0609; B01L 2300/0832; B01L 2300/123

(57) ABSTRACT

A sample storage container includes: a collection container having an open top; a cap configured to open and close an upper portion of the collection container; and a collection stick provided at a lower end of the cap to collect a sample. The collection stick is detachably coupled to the lower end of the cap. The collection stick includes: a coupling ring fitted into a recessed groove formed along an outer circumference of the lower end of the cap; a rod extending downward from the coupling ring; and a contact portion formed on the outer circumference of the rod to come into contact with the sample.

### CROSS-REFERENCE TO RELATED PATENT APPLICATION

This application claims priority to Korean Patent Application No. 10-2024-0152419 (filed on Oct. 31, 2024), which is hereby incorporated by reference in its entirety.

### BACKGROUND

The present invention relates to a sample storage container, and more specifically, to a sample storage container in which a portion that comes into contact with a sample and allows the sample to adhere is integrally formed with a cap, thereby enabling easy sample collection without the need for a swab and allowing a sample or an elution buffer (EB) to be injected into a collection container without separating the cap from the collection container.

In general, it is most accurate to obtain test results when all samples for specimen testing are sent to a laboratory and tested immediately after collection. However, if immediate testing is not possible, the samples must be either preserved under appropriate conditions or transported to the laboratory.

Accordingly, a sample storage container is used for storing and transporting samples. A conventional sample storage container includes: a sterilized collection container for receiving the sample; a cap coupled to an opening of the collection container; and a sterilized disposable swab. The sample is collected using the disposable swab. Then, the tip of the swab to which the sample is adhered is cut and inserted into the collection container, and is then sealed with the cap.

Such a conventional method of collecting samples has a disadvantage of requiring a separate disposable swab in addition to the collection container, making it inconvenient to carry and store. Moreover, the conventional method of collecting samples is inconvenient in cutting the swab tip to which the sample is adhered and inserting the swab tip into the collection container with a narrow opening.

Additionally, in the conventional sample storage container, the cap is simply inserted into or screw-coupled to the opening provided at an upper portion of the collection container. The cap insertion coupling structure allows easier opening and closing compared to the screw coupling structure, but has a problem in which reduced airtightness causes the ingress of foreign substances or the leakage of blood during transportation. The cap screw coupling structure provides better airtightness than the insertion coupling structure, but is less convenient in terms of opening and closing.

The cap coupled to the opening of the collection container is typically formed of a single material using a thermoplastic resin such as polypropylene that has excellent chemical resistance. As described above, when the insertion coupling structure or the screw coupling structure is applied to the opening of the collection container, in order to collect a sample and put it in the collection container, it is essential that the cap is first removed from the collection container and then reattached to the collection container after the sample is placed into the collection container.

In addition, to place the sample collected by a syringe or a pipette into the collection container, an operator must first remove the cap from the collection container, insert a needle of the syringe or a pipette tip of the pipette into the collection container, inject the sample into the collection container, and then reattach the cap to the collection container. So, during the period in which the cap is open, contaminants may enter the collection container, or the detached cap may be reattached to the collection container in a contaminated state, contaminating the interior of the collection container.

Related Art: Korean Utility Model Publication No. 20-2009-(2009.04.15)

### SUMMARY

Accordingly, the present invention has been made to solve the above-mentioned problems occurring in the prior arts, and it is an objective of the present invention to provide a sample storage container in which a portion that comes into contact with a sample and allows the sample to adhere is integrally formed with a cap, thereby enabling easy sample collection without the need for a swab and enabling the collected sample to be easily placed into and stored in a collection container.

It is an objective of the present invention to provide a sample storage container that allows an elution buffer (EB) to be introduced into the collection container containing the collected sample without separating the cap from the collection container, and prevents external air from entering the interior of the collection container so as to avoid contamination of the sample.

To accomplish the above object, according to the present invention, there is provided a sample storage container including: a collection container having an open top; a cap configured to open and close an upper portion of the collection container; and a collection stick provided at a lower end of the cap to collect a sample.

Moreover, the collection stick is detachably coupled to the lower end of the cap.

Furthermore, the collection stick includes: a coupling ring fitted into a recessed groove formed along an outer circumference of the lower end of the cap; a rod extending downward from the coupling ring; and a contact portion formed on the outer circumference of the rod to come into contact with the sample.

Additionally, the collection stick further comprises a plurality of connectors extending from the circumference of the coupling ring and connected to the upper end of the rod.

In addition, the contact portion is formed in a helical shape on the outer circumference of the rod.

Moreover, the contact portion comprises a plurality of protrusions formed on the outer circumference of the rod, and the protrusions are radially arranged on the outer circumference of the rod.

Furthermore, the sample storage container further includes a membrane provided at the center of the cap, made of a material different from the cap, and configured to be penetrated by a needle of a syringe or pipette tip used to collect a sample.

Additionally, the cap is formed by insert injection molding with the membrane embedded in a mold.

In addition, the cap is made of polypropylene, and the membrane is made of an elastomer.

Moreover, a plurality of protrusions and recesses are formed on the inner circumference of the cap which is in contact with the membrane, and the membrane is embedded between the protrusions and recesses.

Furthermore, the membrane has a recessed portion formed on the upper surface thereof to be recessed toward the interior of the collection container.

Additionally, the membrane has a slit formed on an upper surface of the membrane.

In addition, the membrane has a hollow conical shape.

Moreover, the membrane has a nipple formed on a surface of the membrane facing the interior of the collection container.

Furthermore, the membrane has a slit formed on an upper surface of the membrane, and the slit extends toward the nipple.

Additionally, the membrane is provided in a double-layer configuration at the center of the cap.

In addition, a hollow space is formed between the double-layer membranes formed at the center of the cap.

According to the sample storage container of the present invention, the collection stick for collecting a sample is provided on the cap that opens and closes the inlet of the collection container, such that the sample can be collected immediately after removing the cap from the collection container and the cap can be reassembled onto the container. Therefore, there is no need to prepare a separate disposable swab, thereby allowing easy sample collection and minimizing contamination of the sample.

Moreover, according to the present invention, the collection container includes the membrane, which is made of an elastomer with elasticity and is provided at the center of the cap opening and closing the opening of the collection container. The membrane is pierced with a needle of a sampling instrument or a pipette tip to inject a sample or an elution buffer (EB) into the collection container. Accordingly, the sample or EB can be introduced into the collection container without removing the cap from the collection container, allowing for convenient transfer of the sample into the container.

Additionally, after the sample or EB has been completely injected into the collection container, when the needle or the pipette tip is withdrawn from the container, the punctured hole of the membrane made of the elastomer is sealed due to its own elasticity, thus blocking external air from entering the interior of the collection container and preventing contamination of the sample.

### BRIEF DESCRIPTION OF THE DRAWINGS

FIG. 1 and FIG. 2 are an exploded perspective view and a cross-sectional view illustrating a sample storage container according to the present invention.

FIG. 3 is a perspective view illustrating another example of a collection stick in the sample storage container according to the present invention.

FIG. 4 is a cross-sectional view illustrating a cap in the sample storage container according to the present invention.

FIG. 5 is a cross-sectional view illustrating the sample storage container being penetrated by a sampling instrument according to the present invention.

FIG. 6 is a cross-sectional view illustrating a state in which a slit is formed in a membrane of the the sample storage container according to the present invention.

FIGS. 7 to 11 are cross-sectional views illustrating various examples of the membrane in the sample storage container according to the present invention.

### DETAILED DESCRIPTION

Terms and words used in the specification and claims should not be interpreted as limited to their conventional or dictionary meanings, bust should be construed as concepts selected by the inventor as concepts which best illustrate the present invention, and must be interpreted as having meanings and concepts adapted to the scope and spirit of the present invention to aid in understanding the technology of the present invention.

Hereinafter, preferred embodiments of the present invention will be described in detail with reference to the accompanying drawings.

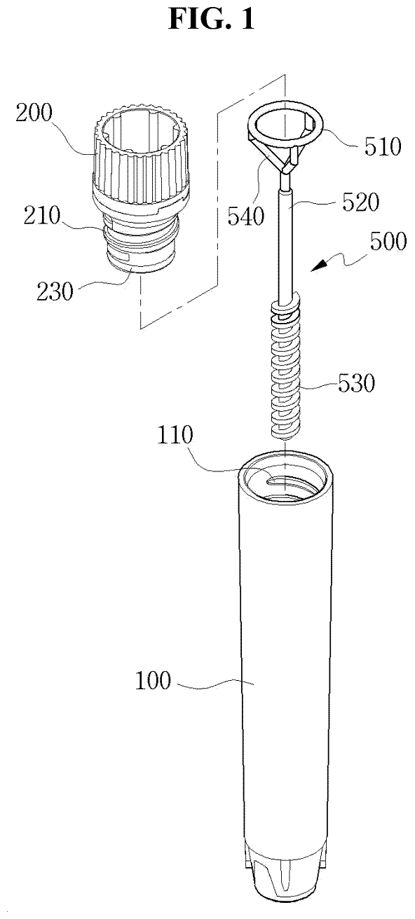

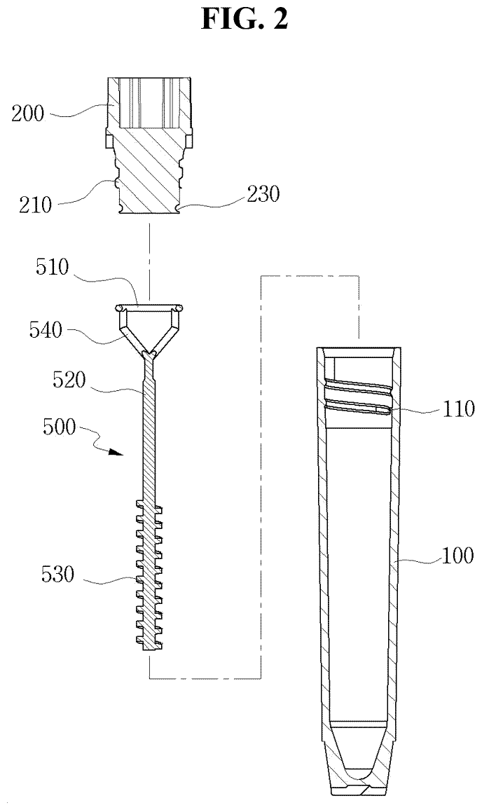

FIGS. 1 and 2 are an exploded perspective view and a cross-sectional view of a sample storage container according to the present invention. Referring to the drawings, the sample storage container of the present invention includes: a collection container 100 having an open top; a cap 200 that opens and closes an upper portion of the collection container 100; and a collection stick 500 provided at the center of the cap 200 and mounted at the lower end of the cap 200 to collect a sample.

In other words, the collection container 100 is formed in the shape of a housing having a space therein to receive a sample and an open top through which the sample can be introduced. Moreover, the collection container 100 is made of a transparent or semi-transparent material to allow visual identification of the presence of the sample from outside.

The collection container 100 is made of a thermoplastic resin such as polypropylene, which has excellent chemical resistance. The collection container 100 includes a male screw thread 110 formed on the outer circumference of the upper end of the collection container 100 so that the cap 200 can be screw-coupled and sealed thereto.

The cap 200, which is coupled to the upper portion of the collection container 100, has a cylindrical shape and is provided with a female screw thread 210 formed on the inner circumferential surface thereof to be screw-coupled with the male screw thread 110 formed on the collection container 100. The outer circumferential surface of the cap 200 may have a polygonal shape or be provided with a fine non-slip slit to allow a user to easily grip and rotate the cap for removal from the collection container. The cap 200 is also made of a thermoplastic resin such as polypropylene, which has excellent chemical resistance.

A collection stick 500 for collecting a sample is provided on the lower end of the cap 200 to allow the user to remove the cap 200 from the collection container 100 and reassemble the cap 200 onto the collection container 100 after collecting a sample using the collection stick 500. Therefore, there is no need to prepare a separate disposable swab, thus facilitating sample collection and minimizing contamination of the sample.

In other words, the collection stick 500 provided on the lower end of the cap 200 includes: a coupling ring 510 fitted into a recessed groove 230 formed along the outer circumference of the lower end of the cap 200; a rod 520 extending downward from the coupling ring 510; and a contact portion 530 formed on the outer circumference of the rod 520 to come into contact with the sample.

The collection stick 500 is made of a flexible material, such that the collection stick 500 is bent according to the shape of an object from which the sample is to be collected, thereby facilitating sample collection. The collection stick 500 having the coupling ring 510 has a detachable structure, in which the coupling ring 510 is fitted into the recessed groove 230 formed on the lower end of the cap 200, thereby allowing the user to detach the collection stick 500 from the cap 200 or reassemble the detached collection stick 500 to the cap 200 as needed.

Additionally, the collection stick 500 includes a plurality of connectors 540 extending from the circumference of the coupling ring 510 and connected to the upper end of the rod 520. Due to the structure, in which the coupling ring 510 and the rod 520 are connected via the connectors 540, a hollow space is formed between the coupling ring 510 and the rod 520. Accordingly, when a membrane (as described later) formed in the cap 200 is pierced by a needle or pipette tip of a sampling instrument, the sample or elution buffer (EB) contained in the sampling instrument can be easily injected into the collection container 100 through the hollow space.

Meanwhile, as illustrated in FIGS. 1 and 2, a contact portion 530 provided on the rod 520 may be formed in a spiral shape along the outer circumference of the rod 520. As described above, since the contact portion 530 is formed in a spiral shape, a contact area between the contact portion 530 and the sample is increased when collecting the sample using the collection stick 500, thereby facilitating sample collection.

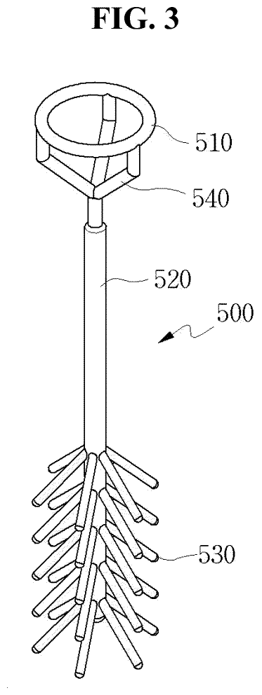

Moreover, the contact portion 530 may be formed in the spiral shape as shown in FIGS. 1 and 2, but in some cases, a plurality of protrusions may be formed on the outer circumference of the rod 520 as illustrated in FIG. 3. The protrusions are radially formed on the outer circumference of the rod 520 to further increase the contact area with the sample.

When the contact portion 530 has the plurality of protrusions, each protrusion is made flexible to be bent naturally upon contact with the sample, thereby further increasing the contact area.

For example, the contact portion 530 formed spirally or having the plurality of protrusions can be used as follows. For example, when collecting oral cells from a patient's mouth, such as the tongue surface or the palate, the collection stick formed spirally may be used to collect a sample. When collecting nasal cavity cells located in a patient's nose, the collection stick having the contact portion formed with the plurality of protrusions may be used to easily collect a sample.

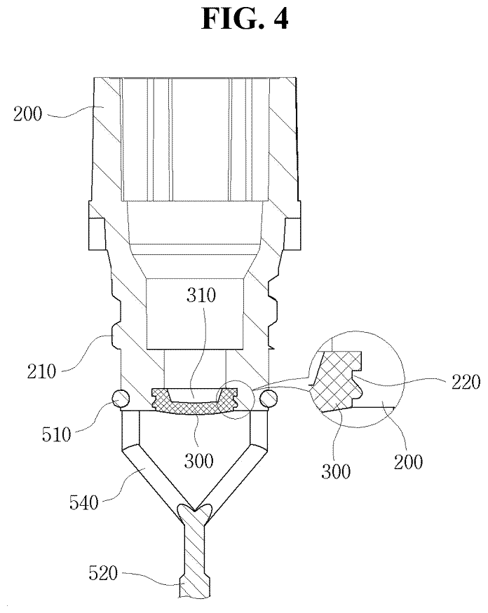

Meanwhile, according to the present invention, the membrane may be provided in the cap 200 such that a sample or an elution buffer (EB) can be introduced into the collection container 100 without removing the cap 200 therefrom. The membrane will be described with reference to FIGS. 4 to 11.

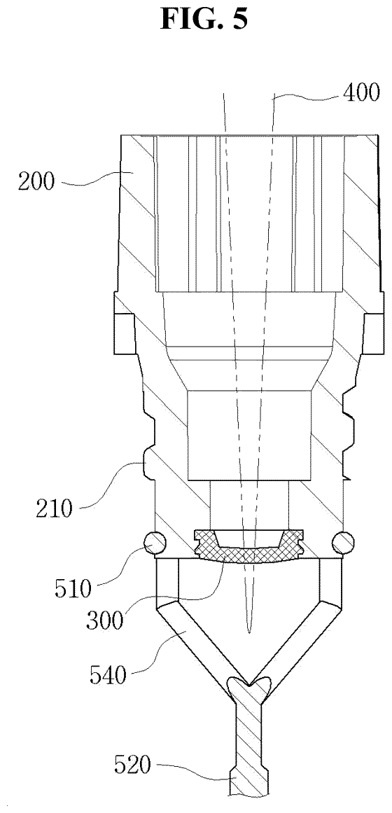

FIG. 4 is a cross-sectional view of the sample storage container according to the present invention, and FIG. 5 is a cross-sectional view illustrating the sample storage container being penetrated by a sampling instrument.

Referring to the drawings, the sample storage container according to the present invention includes a membrane 300 provided at the center of the cap 200, is made of a material different from that of the cap 200, and is configured to be penetrated by a needle or a pipette tip 400 of a sampling instrument containing a sample or elution buffer (EB).

In other words, the cap 200 has the membrane 300 provided at the center thereof and made of a material different from that of the cap 200. Preferably, the membrane 300 is formed of an elastomer exhibiting rubber elasticity at room temperature so that the membrane 300 can be penetrated by the needle or pipette tip 400 of the sampling instrument containing the sample or EB.

The cap 200 is manufactured by insert injection molding in such a manner that the membrane 300 is positioned in a mold during a molding process. As a result, the cap 200 and the membrane 300 are integrally formed as a single structure.

Furthermore, as described above, to ensure that the membrane 300 remains firmly in position at the center of the cap 200 during the insert injection molding of the cap 200 and the the membrane 300, the cap 200 has a plurality of protrusions and recesses 220 formed on the inner circumference thereof in contact with the membrane 300 as shown in the inset of FIG. 4, and the membrane 300 is embedded between the protrusions and recesses 220.

As described above, when the protrusions and recesses 220 are formed on the inner circumference of the cap 200 and the membrane 300 is embedded between the protrusions and recesses 220, the bonding between the cap 200 and the membrane 300 becomes more secure, thus preventing the membrane 300 from being detached from the cap 200 when the user applies pressure to the membrane 300 with the needle or pipette tip 400 of the sampling instrument to pierce the membrane 300.

Additionally, the membrane 300 includes a recessed portion 310 formed on the upper surface thereof to be recessed toward the interior of the collection container 100. The recessed portion 310 formed on the upper surface of the membrane 300 may guide the tip of the needle or pipette tip 400 of the sampling instrument toward the center of the membrane 300 when the user punctures the membrane to inject a sample into the collection container 100, thus allowing the user to stably pierce the membrane 300 with the needle or pipette tip 400 of the sampling instrument.

Unlike the cap 200 made of polypropylene, since the membrane 300 is made of an elastomer and is provided at the center of the cap 200, when injecting the sample or elution buffer (EB) into the collection container 100, the user can puncture the membrane 300 of the cap 200 with the needle or pipette tip 400 of the sampling instrument without removing the cap 200 from the collection container 100, insert the tip of the needle or pipette tip 400 of the sampling instrument into the collection container 100, and then, inject the sample or elution buffer (EB) into the collection container 100.

After the injection of the sample is completed, the needle or pipette tip 400 of the sampling instrument inserted into the collection container 100 is withdrawn. In this instance, as the needle or pipette tip 400 of the sampling instrument is withdrawn from the membrane 300, the membrane 300 made of elastomer exhibits elastic restoring force to automatically seal the hole punctured by the needle or pipette tip 400, thereby transferring the sample of the sampling instrument into the collection container easily without removing the cap 200.

Furthermore, since the membrane 300 is made of an elastomer, the hole created by the needle or pipette tip 400 is automatically sealed by the elastic restoring force of the membrane 300 as soon as the needle or pipette tip 400 of the sampling instrument is withdrawn, thus preventing external air from entering the interior of the collection container 100 and preventing contamination of the sample injected into the collection container.

Meanwhile, the present invention is not limited to the embodiments described above, but may be modified or altered within the scope of the technical idea of the present invention. Such modifications or alterations shall also be considered to fall within the scope of the present invention.

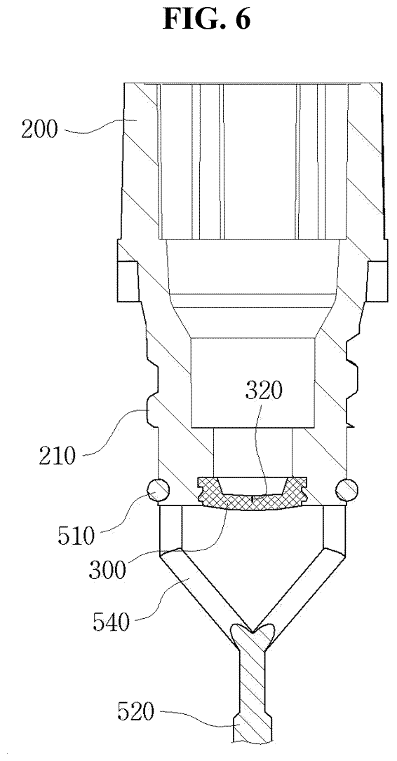

For example, as illustrated in FIG. 6, a slit 320 may be formed on the upper surface of the membrane 300. The slit 320 formed on the membrane 300 may be partially cut from the upper surface toward the lower surface of the membrane 300.

Additionally, the slit 320 formed on the upper surface of the membrane 300 may be formed in a straight or cross shape as viewed from above the cap 200, improving visibility and allowing the user to more easily position the tip of the needle or pipette tip 400 of the sampling instrument on the upper surface of the membrane 300.

As described above, when the slit 320 is formed on the membrane 300, the membrane 300 can be penetrated with less force when the user pierces the membrane 300 with the needle or pipette tip 400 to inject a sample or elution buffer (EB) into the collection container 100. Accordingly, the user can easily insert the needle or pipette tip 400 of the sampling instrument into the interior of the collection container 100.

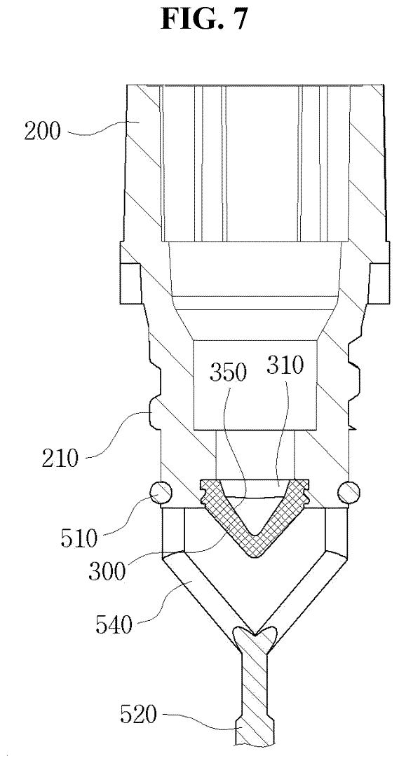

In addition, as illustrated in FIG. 7, the membrane 300 may be configured in a hollow conical shape. When the membrane 300 has the hollow conical shape and the apex of the conical membrane 300 is oriented toward the interior of the collection container 100, The needle or pipette tip 400 of the sampling instrument slides along the inclined surface 350 of the conical membrane formed by the hollow conical shape and is guided toward the apex of the conical membrane 300 when the user inserts the needle or pipette tip 400 of the sampling instrument into the interior of the collection container 100 so that the needle or pipette tip 400 of the sampling instrument can pierce the center of the membrane 300, thus preventing the needle or pipette tip 400 from being blocked by the cap 200 and ensuring smooth introduction of the sample into the interior of the collection container 100.

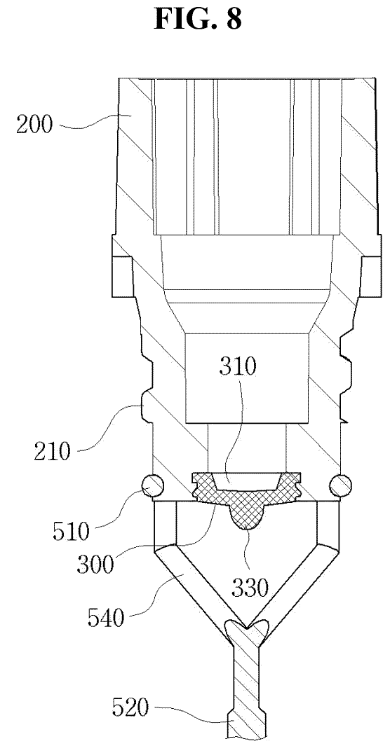

In addition, as illustrated in FIG. 8, a nipple 330 may be formed on the lower surface of the membrane 300 that faces the interior of the collection container 100. Due to the nipple 330 provided on the lower surface of the membrane 300, when the needle or pipette tip 400 of the sampling instrument pierces the membrane 300, the length of a path through which the needle or pipette tip 400 of the sampling instrument penetrates is increased, As a result, the contact area between the membrane 300 and the needle or pipette tip 400 is also increased.

As described above, the increased contact area between the membrane 300 and the needle or pipette tip 400 of the sampling instrument can minimize the introduction of the external air into the collection container 100 through a gap between the membrane 300 and the needle or pipette tip 400 and prevent contamination of the sample when the needle or pipette tip 400 of the sampling instrument pierces the membrane 300.

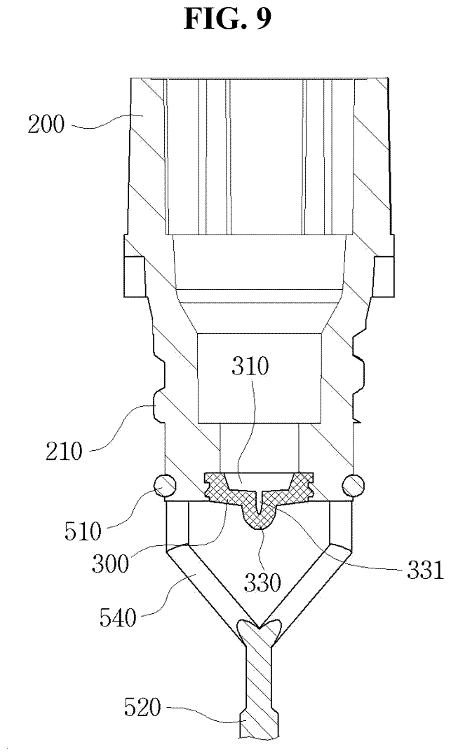

Furthermore, as described above, when the nipple 330 is formed on the membrane 300, a slit 331 may also be formed on the upper surface of the membrane 300, as illustrated in FIG. 9. The slit 331 is formed in a direction extending toward the nipple 330 from the upper surface of the membrane 300.

Due to the nipple 330 and the slit 331 formed on the membrane 300, the membrane can be more easily penetrated with minimal force when the user pierces the membrane 300 with the needle or pipette tip 400 of the sampling instrument to inject the sample or elution buffer (EB) into the collection container 100. Furthermore, the partially cut portion of the membrane 300 comes into close contact with the needle or pipette tip 400 of the sampling instrument, further minimizing the entry of external air into the collection container 100 and preventing sample contamination.

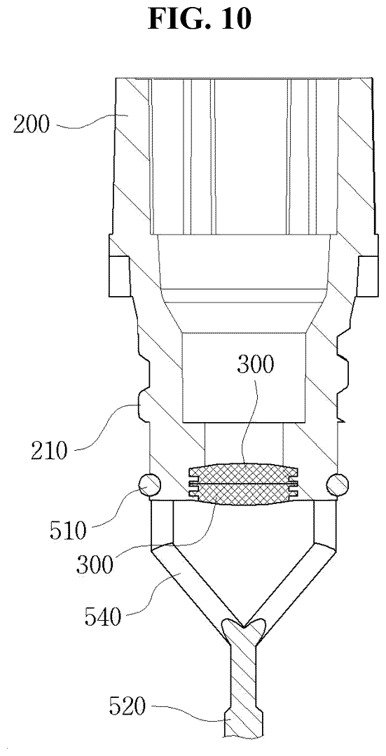

As illustrated in FIG. 10, the membrane 300 may be provided in a double-layer configuration at the center of the cap 200. The dual membranes 300 are stacked one on top of the other at the center of the cap 200. Due to the dual membranes 300 provided on the cap 200, Even if the outer membrane 300 located outside the cap 200 is damaged by an external force and cannot perform its intended function, the inner membrane 300 located inside the cap is protected by the outer membrane 300 and is prevented from being damaged.

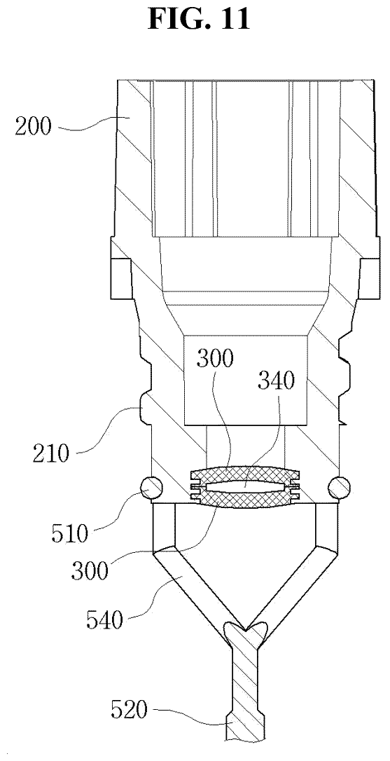

Additionally, as illustrated in FIG. 11, when the dual membranes 300 are provided on the cap 200, a hollow space 340 may be formed between the dual membranes 300. Due to the hollow space 340 formed between the dual membranes 300, when any external force is applied to the outer membrane 300, the external force is buffered by the hollow space 340, such that the force is not directly transmitted to the inner membrane 300, thereby preventing damage to the inner membrane 300 located inside the cap 200.

1. A sample storage container comprising:
a collection container having an open top;
a cap configured to open and close an upper portion of the collection container; and
a collection stick provided at a lower end of the cap to collect a sample.

2. The sample storage container according to claim 1, wherein the collection stick is detachably coupled to the lower end of the cap.

3. The sample storage container according to claim 2, wherein the collection stick comprises:
a coupling ring fitted into a recessed groove formed along an outer circumference of the lower end of the cap;
a rod extending downward from the coupling ring; and
a contact portion formed on the outer circumference of the rod to come into contact with the sample.

4. The sample storage container according to claim 3, wherein the collection stick further comprises a plurality of connectors extending from the circumference of the coupling ring and connected to the upper end of the rod.

5. The sample storage container according to claim 3, wherein the contact portion is formed in a helical shape on the outer circumference of the rod.

6. The sample storage container according to claim 3, wherein the contact portion comprises a plurality of protrusions formed on the outer circumference of the rod, and the protrusions are radially arranged on the outer circumference of the rod.

7. The sample storage container according to claim 1, further comprising:
a membrane provided at the center of the cap, made of a material different from the cap, and configured to be penetrated by a needle of a syringe or pipette tip used to collect a sample.

8. The sample storage container according to claim 7, wherein the cap is formed by insert injection molding with the membrane embedded in a mold.

9. The sample storage container according to claim 7, wherein the cap is made of polypropylene, and the membrane is made of an elastomer.

10. The sample storage container according to claim 7, wherein a plurality of protrusions and recesses are formed on the inner circumference of the cap which is in contact with the membrane, and the membrane is embedded between the protrusions and recesses.

11. The sample storage container according to claim 7, wherein the membrane has a recessed portion formed on the upper surface thereof to be recessed toward the interior of the collection container.

12. The sample storage container according to claim 7, wherein the membrane has a slit formed on an upper surface of the membrane.

13. The sample storage container according to claim 7, wherein the membrane has a hollow conical shape.

14. The sample storage container according to claim 7, wherein the membrane has a nipple formed on a surface of the membrane facing the interior of the collection container.

15. The sample storage container according to claim 14, wherein the membrane has a slit formed on an upper surface of the membrane, and the slit extends toward the nipple.

16. The sample storage container according to claim 7, wherein the membrane is provided in a double-layer configuration at the center of the cap.

17. The sample storage container according to claim 16, wherein a hollow space is formed between the double-layer membranes formed at the center of the cap.
